(19) United States
(12) Patent Application Publication
(10) Pub. No.: US 2019/0389407 A1
(43) Pub. Date: Dec. 26, 2019

(54) ASSEMBLED BATTERY, VEHICLE, AND METHOD OF MANUFACTURING ASSEMBLED BATTERY

(71) Applicant: TOYOTA JIDOSHA KABUSHIKI KAISHA, Toyota-shi (JP)

(72) Inventor: Masaru TAKAGI, Toyota-shi (JP)

(73) Assignee: TOYOTA JIDOSHA KABUSHIKI KAISHA, Toyota-shi (JP)

(21) Appl. No.: 16/387,991

(22) Filed: Apr. 18, 2019

(30) Foreign Application Priority Data
Jun. 25, 2018 (JP) 2018-119701

(51) Int. Cl. B60R 16/033; H01M 2/10; H01M 10/0525; H01M 4/58; H01M 4/485; H01M 4/131; H01M 4/134

(52) U.S. Cl. CPC B60R 16/033; H01M 2/1077; H01M 10/0525; H01M 2220/20; H01M 4/485; H01M 4/131; H01M 4/134; H01M 4/5825

(57) ABSTRACT

An assembled battery includes a cell group. The cell group includes a plurality of cells connected in series. Each of the plurality of cells is a lithium-ion battery. The cell group includes: at least one of a first cell or a second cell; and at least one third cell. The first cell includes a positive electrode active material containing a lithium-nickel composite oxide. The second cell includes a negative electrode active material containing a lithium-titanium composite oxide. The third cell includes a positive electrode active material containing a lithium iron phosphate. A voltage of the assembled battery is within a range of 11.8 V to 14.5 V in a case where an SOC of the assembled battery is within a range of 20% to 80%.

### INCORPORATION BY REFERENCE

The disclosure of Japanese Patent Application No. 2018-119701 filed on Jun. 25, 2018 including the specification, drawings and abstract is incorporated herein by reference in its entirety.

### BACKGROUND

### 1. Technical Field

The present disclosure relates to an assembled battery, a vehicle, and a method of manufacturing an assembled battery.

### 2. Description of Related Art

Japanese Patent Application Publication No. 2011-078147 discloses a vehicle incorporating a lead storage battery.

### SUMMARY

Vehicles are generally equipped with auxiliary equipment and an auxiliary equipment battery. The term “auxiliary equipment” is a generic term used to refer to devices for indirectly assisting the travel of vehicles. Examples of the auxiliary equipment include power steering and air conditioners. An “auxiliary equipment battery” stores electric power to be supplied to the auxiliary equipment. Lead storage batteries have been conventionally used as auxiliary equipment batteries. In recent years, the use of lithium-ion batteries in place of lead storage batteries has been investigated from the viewpoints of, for example, environmental load involved in the use of lead, weight reduction of auxiliary equipment batteries, and electricity efficiency of vehicles.

The present disclosure seeks to provide an assembled battery suitable for an auxiliary equipment battery by using lithium-ion batteries.

Hereinafter, the technical features and effects of the present disclosure will be described. It should be noted that the description of the mechanism of the effects of the present disclosure includes inferences. The scope of the claims should not be limited by whether or not the described mechanism is valid.

An assembled battery according to a first aspect of the present disclosure includes a cell group. The cell group includes a plurality of cells connected in series. Each of the plurality of cells is a lithium-ion battery. The cell group includes: one or more first cells and/or one or more second cells; and one or more third cells. The first cell includes a positive electrode active material containing a lithium-nickel composite oxide. The second cell includes a negative electrode active material containing a lithium-titanium composite oxide. The third cell includes a positive electrode active material containing a lithium iron phosphate. A voltage of the assembled battery is within a range of 11.8 V to 14.5 V in a case where an SOC of the assembled battery is within a range of 20% to 80%.

FIG. 5 is a graph showing the relationships between SOC and voltage in various assembled batteries. As defined in “JIS D 0114”, the “SOC (state of charge)” refers to a percentage determined by subtracting the percentage of the amount of discharged electricity relative to the amount of electricity of the battery fully charged.

A lead storage battery (which may hereinafter be abbreviated as “PbB”) for use in an auxiliary equipment battery is formed of six cells (about 2 V) connected in series. PbB for use in an auxiliary equipment battery has a voltage of about 12 to 13 V at an SOC of 0% or more and 100% or less.

Lithium-ion batteries have different voltages depending on the types of the positive electrode active material and negative electrode active material. One lithium-ion battery using a lithium-nickel composite oxide (such as LiNi_{1/3}Co_{1/3}Mn_{1/3}O₂) in the positive electrode active material (this lithium-ion battery will hereinafter be referred to as “LiB(Ni)”) can alone have a voltage of about 3 to 4.1 V. Connecting three LiB(Ni) in series can form an assembled battery having a voltage of about 9 to 12.3 V. However, this assembled battery (three LiB(Ni) connected in series) has a much lower voltage than PbB and hence has a voltage of less than 11.8 V over a wide SOC range. If the voltage of the assembled battery becomes less than 11.8 V, the battery may fail to provide an output required for actuation of auxiliary equipment.

Connecting four LiB(Ni) in series can form an assembled battery having a voltage of about 12 to 16.4 V. This assembled battery (four LiB(Ni) connected in series) has a much higher voltage than PbB and hence has a voltage of more than 14.5 V at an SOC of around 50%. In order that the capacity region where the voltage is more than 14.5 V may be exploited in 12V circuits in which PbB has been conventionally used, it is considered necessary to decrease the voltage by means of a DC-DC converter.

One LiB using a lithium-titanium composite oxide (such as Li₄Ti₅O₁₂) in the negative electrode active material (this lithium-ion battery may hereinafter be abbreviated as “LiB(Ti)”) can alone have a voltage of about 2 to 2.6 V. Connecting five LiB(Ti) in series can form an assembled battery having a voltage of about 10 to 13 V. This assembled battery (five LiB(Ti) connected in series) has a much lower voltage than PbB and hence has a voltage of less than 11.8 V over a wide SOC range. If the voltage of the assembled battery becomes less than 11.8 V, the battery may fail to provide an output required for actuation of auxiliary equipment.

Connecting six LiB(Ti) in series can form an assembled battery having a voltage of about 12 to 15.6 V. This assembled battery (six LiB(Ti) connected in series) has a much higher voltage than PbB and hence has a voltage of more than 14.5 V at a high SOC. In order that the capacity region where the voltage is more than 14.5 V may be exploited in 12V circuits in which PbB has been conventionally used, it is considered necessary to decrease the voltage by means of a DC-DC converter. Further, this assembled battery (six LiB(Ti) connected in series) has a large total number of cells (i.e., this battery is constituted by a large number of components) and is hence considered uneconomical.

One LiB using a lithium iron phosphate (such as LiFePO₄) in the positive electrode active material (this lithium-ion battery may hereinafter be abbreviated as “LiB(Fe)”) can alone have a voltage of about 2.6 to 3.4 V. Connecting four LiB(Fe) in series can form an assembled battery having a voltage of about 10.4 to 13.6 V. This assembled battery (four LiB(Fe) connected in series) can have a voltage relatively close to that of PbB. However, this assembled battery presents a flat charge-discharge profile, which is thought to make difficult estimation of the SOC from the voltage.

The assembled battery of the present disclosure employs two or three types of LiB selected from LiB(Ni), LiB(Ti), and LiB(Fe). That is, in the assembled battery of the present disclosure, the cell group includes: at least one of one or more first cells (LiB(Ni)) and one or more second cells (LiB(Ti)); and one or more third cells (LiB(Fe)).

In the assembled battery of the present disclosure, the first cell (LiB(Ni)), the second cell (LiB(Ti)), and the third cell (LiB(Fe)) are combined to allow the assembled battery to have a voltage of 11.8 V or more and 14.5 V or less at an SOC of 20% or more and 80% or less. The assembled battery is therefore considered to satisfy properties required of auxiliary equipment batteries over a sufficiently wide SOC range. That is, the assembled battery of the present disclosure is expected to be suitable for an auxiliary equipment battery.

If the voltage at an SOC of 20% is less than 11.8 V, the output may be insufficient at low SOCs. If the voltage at an SOC of 80% is more than 14.5 V, the unusable capacity region may be extended.

By way of example, the graph of FIG. 9 shows an exemplary relationship between SOC and voltage in the assembled battery of the present disclosure. The assembled battery (LiB(Fe)+LiB(Ni)+LiB(Ti)+LiB(Fe)) is formed by serial connection of one first cell (LiB(Ni)), one second cell (LiB(Ti)), and two third cells (LiB(Fe)).

The assembled battery of the present disclosure includes at least one third cell (LiB(Fe)). For example, an auxiliary equipment battery of an electric vehicle is maintained at a voltage of around 14.5 V during travel of the vehicle. As seen from the charge-discharge profile of an assembled battery (four LiB(Fe) connected in series) in FIG. 5, the third cell (LiB(Fe)) shows a sharp increase in voltage at an SOC of about 95% or more. The voltage of an assembled battery is a total voltage of all the cells. For the assembled battery of the present disclosure, it is thought that as the SOC reaches about 95% or more, the voltage of the third cell (LiB(Fe)) increases and correspondingly the voltage of at least one of the first cell (LiB(Ni)) and the second cell (LiB(Ti)) becomes slow to increase. This is expected to reduce deterioration of the first cell (LiB(Ni)) and the second cell (LiB(Ti)). The assembled battery is consequently expected to have a long service life.

As previously described, the third cell (LiB(Fe)) can have a higher voltage than the second cell (LiB(Ti)). The inclusion of at least one third cell (LiB(Fe)) in an assembled battery is thought to enable the assembled battery to require a smaller total number of cells than another assembled battery (six LiB(Ti) connected in series) and have a voltage of 11.8 V or more and 14.5 V or less at an SOC of 20% or more and 80% or less.

Further, the assembled battery of the present disclosure includes at least one of the first cell (LiB(Ni)) and the second cell (LiB(Ti)). This is expected to give a slope to the charge-discharge profile of the assembled battery. The slope given to the charge-discharge profile is expected to allow easy estimation of the SOC from the voltage.

In the first aspect, the plurality of cells may be arranged in a row. The one or more third cells may be disposed at at least one of two ends in a direction in which the plurality of cells are arranged in the row.

Hereinafter, the direction in which a plurality of cells are arranged in a row may be referred to as an “arrangement direction”. When an external impact is applied to the assembled battery, a cell disposed at an end in the arrangement direction is thought to undergo a larger deformation than a cell disposed in the middle in the arrangement direction. The deformation of a cell can cause internal short circuit in the cell.

The third cell (LiB(Fe)) is expected to generate little heat upon internal short circuit, because of the properties of the lithium iron phosphate included in the positive electrode active material of the third cell. Disposing the third cell (LiB(Fe)) at an end in the arrangement direction is expected to reduce the amount of heat generated by the assembled battery subjected to external impact.

In the first aspect, the cell group may include one or more second cells. The plurality of cells may be arranged in a row. The one or more second cells may be disposed at at least one of two ends in a direction in which the plurality of cells are arranged in the row.

The second cell (LiB(Ti)) is expected to generate little heat upon internal short circuit, because of the properties of the lithium-titanium composite oxide included in the negative electrode active material of the second cell. Disposing the second cell (LiB(Ti)) at an end in the arrangement direction is expected to reduce the amount of heat generated by the assembled battery subjected to external impact.

In the first aspect, a difference between the voltage at the SOC of 80% and the voltage at the SOC of 20% may be 0.5 V or more.

A charge-discharge profile with a slope equal to or greater than a certain value is expected to allow easy estimation of the SOC from the voltage (see FIG. 9, for example).

In the first aspect, the cell group may consist, for example, of four cells.

In the first aspect, the cell group may consist, for example, of five cells.

A vehicle according to a second aspect of the present disclosure includes at least one of a travel motor and an engine, auxiliary equipment, and an auxiliary equipment battery. The auxiliary equipment battery is configured to store electric power to be supplied to the auxiliary equipment. The auxiliary equipment battery includes the assembled battery according to the first aspect.

In the second aspect, the vehicle of the present disclosure may include the travel motor. The vehicle of the present disclosure may further include a main battery. The main battery is configured to store at least electric power to be supplied to the travel motor.

The vehicle of the present disclosure may be a gasoline engine vehicle. The vehicle of the present disclosure may be an electric vehicle. The inclusion of the assembled battery of the present disclosure in the auxiliary equipment battery is expected, for example, to reduce the weight of the auxiliary equipment battery. Hence, improvements in fuel efficiency and electricity efficiency of the vehicle are also expected.

A method of manufacturing an assembled battery according to a third aspect of the present disclosure includes at least the following (a), (b), and (c): (a) preparing a plurality of cells; (b) connecting the plurality of cells in series to form a cell group; and (c) producing an assembled battery including the cell group. Each of the plurality of cells is a lithium-ion battery. The cell group includes: one or more first cells and/or one or more second cells; and one or more third cells. The first cell includes a positive electrode active material containing a lithium-nickel composite oxide. The second cell includes a negative electrode active material containing a lithium-titanium composite oxide. The third cell includes a positive electrode active material containing a lithium iron phosphate. In the method of manufacturing an assembled battery according to the present disclosure, the number of the first cells, the number of the second cells, and the number of the third cells included in the cell group are chosen to allow a voltage of the assembled battery to be within a range of 11.8 V to 14.5 V in a case where an SOC of the assembled battery is within a range of 20% to 80%.

With the method of manufacturing an assembled battery according to the third aspect, the assembled battery according to the first aspect can be manufactured.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a perspective view showing an example of the configuration of an assembled battery of the present embodiment;

FIG. 2 is a top view showing an example of the configuration of an assembled battery of the present embodiment;

FIG. 3 is a flowchart showing the outline of the method of manufacturing an assembled battery according to the present embodiment;

FIG. 4 is a block diagram showing an example of the configuration of a vehicle of the present embodiment;

FIG. 5 is a graph showing the relationships between SOC and voltage in various assembled batteries;

FIG. 6 is a graph showing the relationship between SOC and voltage in an assembled battery of Example 1;

FIG. 7 is a graph showing the relationship between SOC and voltage in an assembled battery of Example 2;

FIG. 8 is a graph showing the relationship between SOC and voltage in an assembled battery of Example 3;

FIG. 9 is a graph showing the relationship between SOC and voltage in an assembled battery of Example 4;

FIG. 10 is a graph showing the relationship between SOC and voltage in an assembled battery of Example 5; and

FIG. 11 is a graph showing the relationship between SOC and voltage in an assembled battery of Example 6.

### DETAILED DESCRIPTION OF EMBODIMENTS

Hereinafter, an embodiment of the present disclosure (this embodiment may hereinafter be referred to as “present embodiment”) will be described. It should be noted that the following description is not intended to limit the scope of the claims.

Assembled Battery

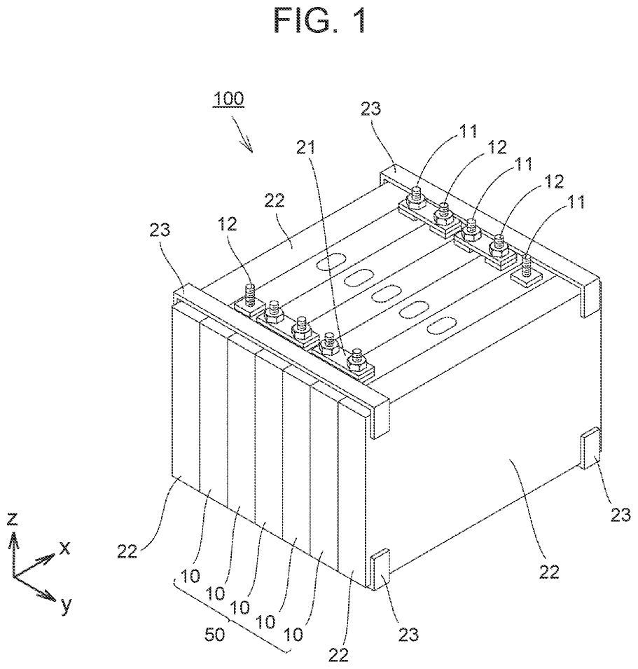

FIG. 1 is a perspective view showing an example of the configuration of an assembled battery of the present embodiment. The assembled battery 100 of the present embodiment is compatible with circuits in which PbB has been conventionally used. The assembled battery 100 can be, for example, for use in an auxiliary equipment battery for vehicles. The assembled battery 100 may be used in applications other than auxiliary equipment batteries. The assembled battery 100 may be used, for example, in an uninterruptible power supply (UPS), a main battery for small vehicles, a stationary power supply, a power source for ship and vessel, or an emergency power supply for wireless base stations.

The assembled battery 100 includes a cell group 50. The cell group 50 may be housed in a given case (not shown). The assembled battery 100 may further include, for example, a protection circuit, various sensors (such as a temperature sensor), and a temperature control system.

The cell group 50 consists of a plurality of cells 10. Each cell 10 of FIG. 1 is a prismatic cell. The prismatic cell has an outer shape of rectangular parallelepiped. However, the cell 10 should not be limited to a prismatic cell. The cell 10 may be, for example, a cylindrical cell. The cell 10 may be, for example, a laminated cell.

In the cell group 50, the plurality of cells 10 are arranged in a row. In FIG. 1, the y-axis direction corresponds to the “arrangement direction”. Each cell 10 is disposed in such a manner that among the side surfaces of the cell 10, the side surface having the largest area is orthogonal to the arrangement direction. Each cell 10 has a positive electrode terminal 11 and a negative electrode terminal 12. Screw threads may be formed on the surfaces of the positive electrode terminal 11 and the negative electrode terminal 12. That is, the positive electrode terminal 11 and the negative electrode terminal 12 may each be a bolt.

The plurality of cells 10 are arranged in such a manner that the positive electrode terminal 11 of each of the cells 10 adjacent in the arrangement direction is adjacent to the negative electrode terminal 12 of another of the cells 10. The bus bar 21 provides electrical connection between the positive electrode terminal 11 and negative electrode terminal 12 adjacent to each other. That is, the cell group 50 is formed by serial connection of the plurality of cells 10.

In the arrangement direction, end plates 22 are disposed respectively on both sides of the cell group 50. Each end plate 22 may be, for example, a plate made of resin. Binding bands 23 provide coupling between the two end plates 22. The two end plates 22 may sandwich the cell group 50 with a given pressure. Intermediate plates (not shown) may be disposed between the cells 10. The intermediate plate may be provided with a projection, groove, or the like that can form a flow path of a refrigerant.

The assembled battery 100 may include a single cell group 50. The assembled battery 100 may include a plurality of cell groups 50. When the assembled battery 100 includes a plurality of cell groups 50, the cell groups 50 may be connected in parallel.

Lithium-Ion Battery

Each cell 10 is a lithium-ion battery. The term “lithium-ion battery” refers to a storage battery in which lithium ions (Li⁺) serve as a charge carrier. The lithium-ion battery includes at least a case, a positive electrode, a negative electrode, and an electrolyte. The positive electrode, the negative electrode, and the electrolyte are housed in the case. The electrolyte may be a liquid. The electrolyte may be a gel. The electrolyte may be a solid. That is, the lithium-ion battery may be an all-solid-state battery.

The lithium-ion battery may further include a separator. The separator can be disposed between the positive electrode and the negative electrode. The separator is an insulating porous film. When the lithium-ion battery is an all-solid-state battery, the separator may be essentially unnecessary.

The cell group 50 includes two or three types of lithium-ion batteries. That is, the cell group 50 consists of: at least one of one or more first cells and one or more second cells; and one or more third cells.

First Cell: LiB(Ni)

The first cell can have, for example, a voltage of 3 V or more and 4.1 V or less at an SOC of 0% or more and 100% or less. The first cell includes at least a positive electrode, a negative electrode, and an electrolyte. The positive electrode includes at least a positive electrode active material. The positive electrode active material includes a lithium-nickel composite oxide. That is, the first cell includes a positive electrode active material including a lithium-nickel composite oxide.

A “lithium-nickel composite oxide” is a compound containing lithium (Li), nickel (Ni), and oxygen (O) as essential constituents. The lithium-nickel composite oxide may have a crystal structure, for example, of the bedded salt type.

The lithium-nickel composite oxide can be represented, for example, by the following formula (1):

LiNi₁₋ₓ₁M¹ₓ₁O₂ (1)

wherein M¹ is at least one selected from the group consisting of Co, Mn, and Al, and x1 satisfies 0≤x1<1.

The lithium-nickel composite oxide may contain a trace amount of element other than Li, Ni, cobalt (Co), manganese (Mn), aluminum (Al), and O. The “trace amount” can be, for example, an amount of 1 mol % or less. The element contained in a trace amount can be, for example, an inevitable impurity element such as sulfur (S) or an added element such as tungsten (W) or fluorine (F).

In the above formula (1), x1 may satisfy, for example, 0.3≤x1≤0.9. x1 may satisfy, for example, 0.3≤x1≤0.8. x1 may satisfy, for example, 0.3≤x1≤0.7. x1 may satisfy, for example, 0.3≤x1≤0.6. x1 may satisfy, for example, 0.3≤x1≤0.5. x1 may satisfy, for example, 0.3≤x1≤0.4.

The lithium-nickel composite oxide may be a lithium-nickel-cobalt-manganese composite oxide (commonly also referred to as “ternary oxide”, “NCM”, “NMC”, or the like). The term “lithium-nickel-cobalt-manganese composite oxide” refers to a compound of the above formula (1) that contains both Co and Mn.

The lithium-nickel composite oxide may be, for example, LiNi_{1/3}Co_{1/3}Mn_{1/3}O₂, LiNi_{0.4}Co_{0.3}Mn_{0.3}O₂, LiNi_{0.4}Co_{0.4}Mn_{0.2}O₂, LiNi_{0.4}Co_{0.2}Mn_{0.4}O₂, LiNi_{0.5}CO_{0.3}Mn_{0.2}O₂, LiNi_{0.5}Co_{0.2}Mn_{0.3}O₂, LiNi_{0.6}CO_{0.3}Mn_{0.1}O₂, LiNi_{0.6}CO_{0.2}Mn_{0.2}O₂, LiNi_{0.7}Co_{0.2}Mn_{0.1}O₂, LiNi_{0.8}Co_{0.15}Al_{0.05}O₂, LiNi_{0.9}Co_{0.05}Mn_{0.05}O₂, or LiNiO₂. The positive electrode active material may include one lithium-nickel composite oxide alone. The positive electrode active material may include two or more lithium-nickel composite oxides.

In the first cell, 60% by mass or more of the positive electrode active material may be constituted by a lithium-nickel composite oxide. In the first cell, 80% by mass or more of the positive electrode active material may be constituted by a lithium-nickel composite oxide. In the first cell, the positive electrode active material may consist essentially of a lithium-nickel composite oxide. For the first cell, possible examples of positive electrode active materials that may be contained other than lithium-nickel composite oxides include LiCoO₂, LiMnO₂, and LiMn₂O₄.

The positive electrode of the first cell may further include, for example, a conductive material, a binder, and a current collector in addition to the positive electrode active material. The conductive material may be, for example, carbon black. The binder may be, for example, polyvinylidene fluoride (PVdF). The current collector may be, for example, an Al foil.

The negative electrode active material of the first cell should not be particularly limited. The negative electrode active material of the first cell may include, for example, at least one selected from the group consisting of graphite, graphitizable carbon, non-graphitizable carbon, silicon, silicon oxide, silicon-based alloy, tin, tin oxide, tin-based alloy, Li (pure metal), and Li alloy. It should be noted that the negative electrode active material of the first cell is desirably free of any lithium-titanium composite oxide.

The negative electrode of the first cell may further include, for example, a binder and a current collector in addition to the negative electrode active material. The binder may be, for example, carboxymethyl cellulose (CMC) or styrene-butadiene rubber (SBR). The current collector may be, for example, a copper (Cu) foil.

The electrolyte of the first cell should not be particularly limited. The electrolyte may be, for example, an electrolyte solution. The electrolyte solution contains a solvent and a Li salt. The solvent may be, for example, a mixture of a cyclic carbonate (such as ethylene carbonate) and a chain carbonate (such as dimethyl carbonate). The Li salt may be, for example, LiPF₆.

Second Cell: LiB(Ti)

The second cell can have, for example, a voltage of 2 V or more and 2.6 V or less at an SOC of 0% or more and 100% or less. The second cell includes at least a positive electrode, a negative electrode, and an electrolyte. The negative electrode includes at least a negative electrode active material. The negative electrode active material includes a lithium-titanium composite oxide. That is, the second cell includes a negative electrode active material including a lithium-titanium composite oxide.

A “lithium-titanium composite oxide” is a compound containing Li, titanium (Ti), and O as essential constituents. The lithium-titanium composite oxide may have a crystal structure, for example, of the spinel type or the ramsdellite type.

The lithium-titanium composite oxide can be represented, for example, by the following formula (2):

Li₄Ti₅₋ₓ₂M²ₓ₂O₁₂ (2)

wherein M² is at least one selected from the group consisting of Mn and Nb, and x2 satisfies 0≤x2<5.

The lithium-titanium composite oxide may contain a trace amount of element other than Li, Ti, Mn, Nb (niobium), and O. The element contained in a trace amount can be, for example, an inevitable impurity element or an added element. In the above formula (2), x2 may satisfy, for example, 0≤x2≤1. The lithium-titanium composite oxide may be, for example, Li₄Ti₅O₁₂.

The second cell is expected to generate little heat upon internal short circuit. It is thought that the occurrence of internal short circuit in the second cell causes release of Li⁺ from the lithium-titanium composite oxide contained in the negative electrode, leading to an increase in the resistance of the lithium-titanium composite oxide. The increased resistance is expected to prevent spread of the short circuit current and reduce the heat to be generated.

In the second cell, 60% by mass or more of the negative electrode active material may be constituted by a lithium-titanium composite oxide. In the second cell, 80% by mass or more of the negative electrode active material may be constituted by a lithium-titanium composite oxide. In the second cell, the negative electrode active material may consist essentially of a lithium-titanium composite oxide. For the second cell, possible examples of negative electrode active materials that may be contained other than lithium-titanium composite oxides include graphite and silicon oxide.

The negative electrode of the second cell may further include, for example, a binder and a current collector in addition to the negative electrode active material. The binder and the current collector may be materials mentioned as examples for the negative electrode of the first cell.

The positive electrode active material of the second cell should not be particularly limited. The positive electrode active material of the second cell may include, for example, a lithium-manganese composite oxide (such as LiMn₂O₄) or a lithium-nickel composite oxide. It should be noted that the positive electrode active material of the second cell is desirably free of any lithium iron phosphate. The positive electrode of the second cell may further include, for example, a conductive material, a binder, and a current collector in addition to the positive electrode active material. The conductive material, binder, and current collector may be materials mentioned as examples for the positive electrode of the first cell.

The electrolyte of the second cell should not be particularly limited. The electrolyte of the second cell may be a material mentioned as an example for the electrolyte of the first cell.

Third Cell: LiB(Fe)

The third cell can have, for example, a voltage of 2.6 V or more and 3.4 V or less at an SOC of 0% or more and 100% or less. The charge-discharge profile of the third cell can be flat over the SOC range of 5% to 95%. The third cell includes at least a positive electrode, a negative electrode, and an electrolyte. The positive electrode includes at least a positive electrode active material. The positive electrode active material includes a lithium iron phosphate. That is, the third cell includes a positive electrode active material including a lithium iron phosphate.

A “lithium iron phosphate” is a composite phosphate containing Li and iron (Fe) as essential constituents. The lithium iron phosphate may have a crystal structure, for example, of the olivine type.

The lithium iron phosphate can be represented, for example, by the following formula (3):

LiFe₁₋ₓ₃M³ₓ₃PO₄ (3)

wherein M³ is at least one selected from the group consisting of Co and Mn, and x3 satisfies 0≤x3<1.

The lithium iron phosphate may contain a trace amount of element other than Li, Fe, Co, Mn, P (phosphorus), and O. The element contained in a trace amount can be, for example, an inevitable impurity element or an added element. In the above formula (3), x3 may satisfy, for example, 0≤x3≤0.5. The lithium iron phosphate may be, for example, LiFePO₄.

In the third cell, 60% by mass or more of the positive electrode active material may be constituted by a lithium iron phosphate. In the third cell, 80% by mass or more of the positive electrode active material may be constituted by a lithium iron phosphate. In the third cell, the positive electrode active material may consist essentially of a lithium iron phosphate. For the third cell, possible examples of positive electrode active materials that may be contained other than lithium iron phosphates include LiCoO₂.

The third cell is expected to generate little heat upon internal short circuit. This is thought to be because the bond between phosphorus and oxygen in the lithium iron phosphate is so strong that even a rise in cell temperature caused by internal short circuit cannot readily cause oxygen release from the lithium iron phosphate.

The positive electrode of the third cell may further include, for example, a conductive material, a binder, and a current collector in addition to the positive electrode active material. The conductive material, binder, and current collector may be materials mentioned as examples for the positive electrode of the first cell.

The negative electrode active material of the third cell should not be particularly limited. The negative electrode active material of the third cell may be, for example, a material mentioned as an example of the negative electrode active material of the first cell. It should be noted that the negative electrode active material of the third cell is desirably free of any lithium-titanium composite oxide. The negative electrode of the third cell may further include, for example, a binder and a current collector in addition to the negative electrode active material.

The electrolyte of the third cell should not be particularly limited either. The electrolyte of the third cell may be a material mentioned as an example for the electrolyte of the first cell.

Charge-Discharge Profile of Assembled Battery

The assembled battery 100 has a voltage of 11.8 V or more and 14.5 V or less at an SOC of 20% or more and 80% or less. That is, at least one of one or more first cells and one or more second cells are combined with one or more third cells to allow the assembled battery 100 to have a voltage of 11.8 V or more and 14.5 V or less at an SOC of 20% or more and 80% or less.

In the present embodiment, when an open circuit voltage (OCV) measured at an SOC of 20% is 11.8 V or more while an OCV measured at an SOC of 80% is 14.5 V or less, it is determined that the assembled battery 100 has a voltage of 11.8 V or more and 14.5 V or less at an SOC of 20% or more and 80% or less.

The OCV is desirably measured as follows. First, the assembled battery 100 is fully discharged. After being fully discharged, the assembled battery 100 is charged with an amount of electricity corresponding to an SOC of 20% (or 80%). The current rate during charge is 0.1 C or more and 0.5 C or less. A current rate of “1 C” refers to the current rate at which the rated capacity of the assembled battery 100 is discharged in 1 hour. After being charged, the assembled battery 100 is left at room temperature (20±5° C.) for 1 hour. After that, the OCV is measured. The OCV can be measured with a common voltmeter. The value of the OCV is significant to one decimal place. The measured value of the OCV is rounded to one decimal place. The OCV is measured three times. An arithmetic mean of the three measurements is adopted.

The assembled battery 100 may have, for example, a voltage of 11.9 V or more at an SOC of 20%. The assembled battery 100 may have, for example, a voltage of 12.1 V or more at an SOC of 20%. The assembled battery 100 may have, for example, a voltage of 13.9 V or less at an SOC of 80%. The assembled battery 100 may have, for example, a voltage of 13.0 V or less at an SOC of 80%. In these cases, the assembled battery 100 is expected to be more suitable for circuits in which PbB has been conventionally used.

It is expected that the wider is the SOC range over which the assembled battery 100 has a voltage of 11.8 V or more and 14.5 V or less, the more the usable capacity region becomes extended. The assembled battery 100 may have, for example, a voltage of 11.8 V or more and 14.5 V or less at an SOC of 10% or more and 90% or less. The assembled battery 100 may have, for example, a voltage of 11.8 V or more and 14.5 V or less at an SOC of 5% or more and 95% or less. The assembled battery 100 may have, for example, a voltage of 11.8 V or more and 14.5 V or less at an SOC of 5% or more and 100% or less.

A charge-discharge profile with a slope equal to or greater than a certain value is expected to allow easy estimation of the SOC from the voltage. For example, the difference between the voltage at an SOC of 80% and the voltage at an SOC of 20% may be 0.5 V or more. This difference is calculated by subtracting the OCV at an SOC of 20% from the OCV at an SOC of 80%. The difference between the voltage at an SOC of 80% and the voltage at an SOC of 20% may be, for example, 0.7 V or more. The difference between the voltage at an SOC of 80% and the voltage at an SOC of 20% may be, for example, 0.9 V or more. The difference between the voltage at an SOC of 80% and the voltage at an SOC of 20% may be, for example, 1.0 V or more. The difference between the voltage at an SOC of 80% and the voltage at an SOC of 20% may be, for example, 1.2 V or more.

The slope of the charge-discharge profile can be calculated by the following formula (4):

Slope [mV/%]={(V₂−V₁)÷(80−20)}×1000 (4)

wherein V₁ denotes the OCV at an SOC of 20%, and V₂ denotes the OCV at an SOC of 80%.

The value of the slope calculated by the above formula (4) is significant to one decimal place. The calculated value is rounded to one decimal place. The slope may be, for example, 8.3 mV/% or more. The slope may be, for example, 11.7 mV/% or more. The slope may be, for example, 15.0 mV/% or more. The slope may be, for example, 16.7 mV/% or more. The slope may be, for example, 20.0 mV/% or less.

Number of Cells

The number of the cells 10 included in the cell group 50 should not be particularly limited as long as the assembled battery 100 has a voltage of 11.8 V or more and 14.5 V or less at an SOC of 20% or more and 80% or less. The cell group 50 may consist, for example, of four cells 10. The cell group 50 may consist, for example, of five cells 10.

The number of the first cells may be, for example, zero or one. The number of the first cells may be, for example, one or two. The number of the first cells may be, for example, zero to two.

The number of the second cells may be, for example, zero or one. The number of the second cells may be, for example, zero to three. The number of the second cells may be, for example, three or four. The number of the second cells may be, for example, zero to four. The number of the second cells may be, for example, one to four. The number of the second cells may be, for example, zero to three.

The number of the third cells may be, for example, one or two. The number of the third cells may be, for example, two or three. The number of the third cells may be, for example, one to three.

Serial Connection of Four Cells

The cell group 50 may consist, for example, of two first cells, zero second cell, and two third cells. The cell group 50 may consist, for example, of one first cell, zero second cell, and three third cells. The cell group 50 may consist, for example, of zero first cell, one second cell, and three third cells. The cell group 50 may consist, for example, of one first cell, one second cell, and two third cells.

Serial Connection of Five Cells

The cell group 50 may consist, for example, of zero first cell, three second cells, and two third cells. The cell group 50 may consist, for example, of zero first cell, four second cells, and one third cell.

Arrangement of Cells

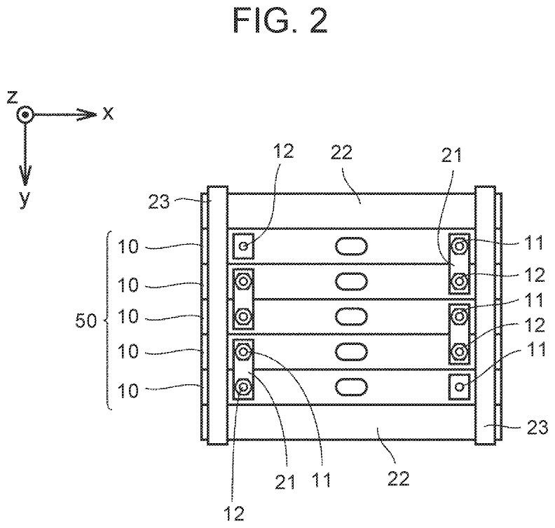

FIG. 2 is a top view showing an example of the configuration of the assembled battery of the present embodiment. In the cell group 50, the third cell may be disposed at at least one of the two ends in the arrangement direction (the y-axis direction in FIG. 2). The third cell, which has a positive electrode containing a lithium iron phosphate, is expected to generate little heat upon internal short circuit. Disposing the third cell at at least one of the two ends in the arrangement direction is expected to reduce the amount of heat generated by the assembled battery 100 subjected to external impact. The third cell may be disposed at one end in the arrangement direction. The third cells may be disposed at the two ends in the arrangement direction.

When the cell group 50 includes one or more second cells, the second cell may be disposed at at least one of the two ends in the arrangement direction (the y-axis direction in FIG. 2). The second cell, which has a negative electrode containing a lithium-titanium composite oxide, is expected to generate little heat upon internal short circuit. Disposing the second cell at least one of the two ends in the arrangement direction is expected to reduce the amount of heat generated by the assembled battery 100 subjected to external impact. The second cell may be disposed at one end in the arrangement direction. The second cells may be disposed at the two ends in the arrangement direction.

For example, the third cell may be disposed at one end in the arrangement direction, while the second cell may be disposed at the other end in the arrangement direction.

First Variant

According to the present disclosure, an assembled battery compatible with 24V circuits can also be provided. For example, two assembled batteries of the present disclosure may be used by being connected in series. Alternatively, one assembled battery of the present disclosure may have the following configuration.

That is, the assembled battery includes a cell group; the cell group is formed of a plurality of cells connected in series; each of the plurality of cells is a lithium-ion battery; the cell group consists of at least one of one or more first cells and one or more second cells, and one or more third cells; the first cell includes a positive electrode active material including a lithium-nickel composite oxide; the second cell includes a negative electrode active material including a lithium-titanium composite oxide; the third cell includes a positive electrode active material including a lithium iron phosphate; and the assembled battery has a voltage of 23.6 V or more and 29 V or less at an SOC of 20% or more and 80% or less.

In the assembled battery of the first variant, the cell group 50 may consist, for example, of 8 to 10 cells 10.

Second Variant

According to the present disclosure, an assembled battery compatible with 36V circuits can also be provided. For example, three assembled batteries of the present disclosure may be used by being connected in series. Alternatively, one assembled battery of the present disclosure may have the following configuration.

That is, the assembled battery includes a cell group; the cell group is formed of a plurality of cells connected in series; each of the plurality of cells is a lithium-ion battery; the cell group consists of at least either one or more first cells or one or more second cells and one or more third cells; the first cell includes a positive electrode active material including a lithium-nickel composite oxide; the second cell includes a negative electrode active material including a lithium-titanium composite oxide; the third cell includes a positive electrode active material including a lithium iron phosphate; and the assembled battery has a voltage of 35.4 V or more and 43.5 V or less at an SOC of 20% or more and 80% or less.

In the assembled battery of the second variant, the cell group 50 may consist, for example, of 12 to 15 cells 10.

Third Variant

According to the present disclosure, an assembled battery compatible with 48V circuits can also be provided. For example, four assembled batteries of the present disclosure may be used by being connected in series. Alternatively, one assembled battery of the present disclosure may have the following configuration.

That is, the assembled battery includes a cell group; the cell group is formed of a plurality of cells connected in series; each of the plurality of cells is a lithium-ion battery; the cell group consists of at least either one or more first cells or one or more second cells and one or more third cells; the first cell includes a positive electrode active material including a lithium-nickel composite oxide; the second cell includes a negative electrode active material including a lithium-titanium composite oxide; the third cell includes a positive electrode active material including a lithium iron phosphate; and the assembled battery has a voltage of 47.2 V or more and 58 V or less at an SOC of 20% or more and 80% or less.

In the assembled battery of the third variant, the cell group 50 may consist, for example, of 16 to 20 cells 10.

In the assembled batteries of the first, second, and third variants, the third cell may be disposed at at least one of the two ends in the arrangement direction. The second cell may be disposed at at least one of the two ends in the arrangement direction.

Method of Manufacturing Assembled Battery

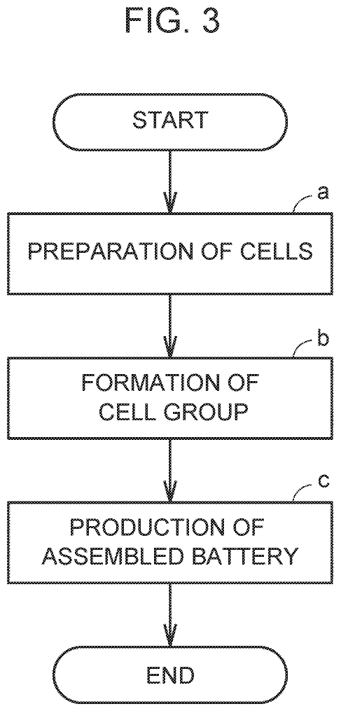

FIG. 3 is a flowchart showing the outline of the method of manufacturing an assembled battery according to the present embodiment. The method of manufacturing an assembled battery according to the present embodiment includes at least “(a) preparation of cells”, “(b) formation of cell group”, and “(c) production of assembled battery”.

(a) Preparation of Cells

The method of manufacturing an assembled battery according to the present embodiment includes preparing the plurality of cells 10. For example, the plurality of cells 10 may be prepared by purchasing commercially-available lithium-ion batteries. For example, the plurality of cells 10 may be prepared by producing lithium-ion batteries. The production of lithium-ion batteries can be carried out by a conventionally known production method.

The plurality of cells 10 are prepared so as to include: at least one of one or more first cells and one or more second cells; and one or more third cells. The details of the first cell, second cell, and third cell are as previously described.

(b) Formation of Cell Group

The method of manufacturing an assembled battery according to the present embodiment includes connecting the plurality of cells 10 in series to form the cell group 50.

For example, the plurality of cells 10 are arranged in a row (see FIG. 1 and FIG. 2). The plurality of cells 10 are arranged in such a manner that the positive electrode terminal 11 of each of the cells 10 adjacent in the arrangement direction is adjacent to the negative electrode terminal 12 of another of the cells 10. The positive electrode terminal 11 and the negative electrode terminal 12 adjacent to each other are connected by the bus bar 21. When the positive electrode terminal 11 and the negative electrode terminal 12 are bolts, the bus bar 21 is fixed by the given nuts. Thus, the plurality of cells 10 are connected in series. By the serial connection of the plurality of cells 10, the cell group 50 is formed.

In the method of manufacturing an assembled battery according to the present embodiment, the respective numbers of the first cells, the second cells, and the third cells included in the cell group 50 are chosen to allow the assembled battery 100 to have a voltage of 11.8 V or more and 14.5 V or less at an SOC of 20% or more and 80% or less.

(c) Production of Assembled Battery

The method of manufacturing an assembled battery according to the present embodiment includes producing the assembled battery 100 including the cell group 50.

The end plates 22 are disposed respectively on both sides of the cell group 50. The two end plates 22 are coupled by the binding bands 23. For example, the cell group 50 is housed in a given case. Thus, the assembled battery 100 including the cell group 50 can be produced.

Vehicle

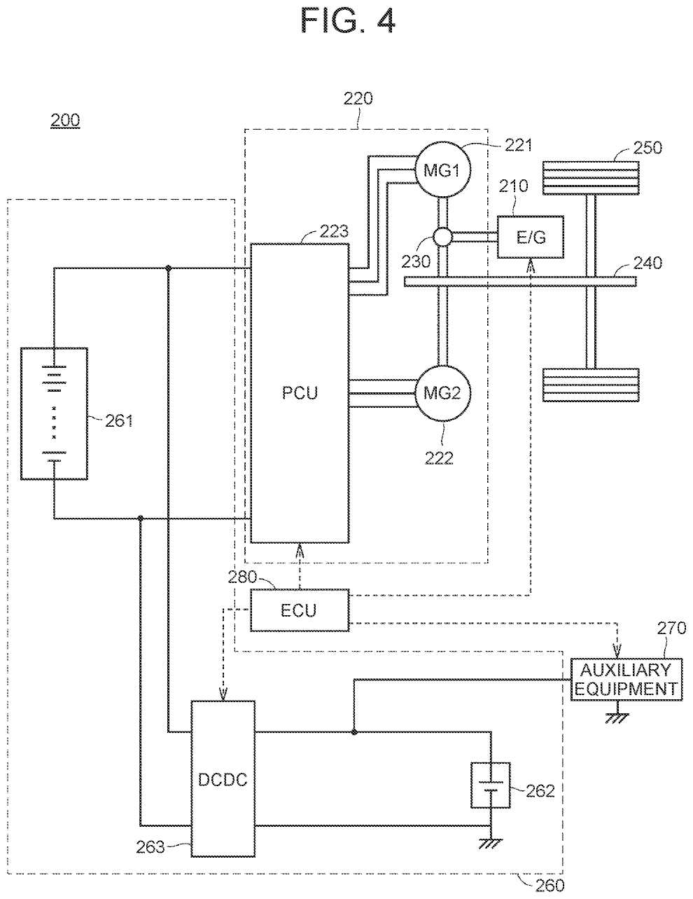

FIG. 4 is a block diagram showing an example of a vehicle of the present embodiment. The vehicle 200 includes an engine 210, a load 220 (including a first motor generator 221 (MG 1) and a second motor generator 222 (MG 2)), a power divider 230, a transmission gear 240, drive wheels 250, a power supply system 260 (including a main battery 261 and an auxiliary equipment battery 262), auxiliary equipment 270, and an electronic control unit (ECU) 280.

The vehicle 200 is a hybrid vehicle (HV). That is, the vehicle 200 can travel by relying on a driving force output from at least one of the engine 210 and the second motor generator 222. In the vehicle 200, the second motor generator 222 corresponds to a “travel motor”.

It should be noted that the HV is merely an example of the vehicle of the present embodiment. The vehicle of the present embodiment may be an electric vehicle (EV). That is, the vehicle of the present embodiment may have no engine. The vehicle of the present embodiment may be a gasoline engine vehicle. That is, the vehicle of the present embodiment may have no travel motor. The vehicle of the present embodiment may be a fuel cell vehicle (FCV). That is, the vehicle may further include, for example, a hydrogen tank.

Thus, the vehicle of the present embodiment includes at least: at least one of a travel motor and an engine; auxiliary equipment; and an auxiliary equipment battery. The auxiliary equipment battery includes the assembled battery 100 described above. The vehicle of the present embodiment may include a travel motor and further include a main battery. The following will describe the various devices included in the vehicle 200.

Engine

The engine 210 converts thermal energy generated by burning of gasoline to kinetic energy for movable parts (such as a piston and a rotor). The engine 210 outputs the kinetic energy to the power divider 230.

Power Divider

The power divider 230 may include, for example, a planetary gear. The power divider 230 divides the kinetic energy into a first driving force and a second driving force. The first driving force acts to drive the drive wheels 250. The first driving force is transmitted from the power divider 230 to the drive wheels 250 via the transmission gear 240. The second driving force acts to drive the first motor generator 221.

Load

The load 220 includes a first motor generator 221, a second motor generator 222, and a power control unit (PCU) 223. The PCU 223 is connected to the first motor generator 221, the second motor generator 222, and the main battery 261. The PCU 223 performs electric power conversion between the first motor generator 221 and the main battery 261 and between the second motor generator 222 and the main battery 261.

The PCU 223 may include, for example, a first inverter (not shown) and a second inverter (not shown). The first inverter converts electric power generated by the first motor generator 221 to direct-current power and inputs the direct-current power to the main battery 261. Upon start-up of the engine 210, the first inverter converts direct-current power supplied from the main battery 261 to alternating-current power and inputs the alternating-current power to the first motor generator 221.

The second inverter converts direct-current power supplied from the main battery 261 to alternating-current power and inputs the alternating-current power to the second motor generator 222. The second inverter converts alternating-current power generated by the second motor generator 222, for example, upon deceleration of the vehicle 200 to direct-current power and inputs the direct-current power to the main battery 261.

The first motor generator 221 and the second motor generator 222 are each an alternating-current motor. The alternating-current motor may be, for example, a three-phase alternating-current motor. The first motor generator 221 converts kinetic energy generated by the engine 210 to electric energy and inputs the electric energy to the PCU 223. The first motor generator 221 uses alternating-current power supplied from the PCU 223 to generate a driving force in order to start up the engine 210.

The second motor generator 222 uses alternating-current power supplied from the PCU 223 to generate a driving force for allowing the vehicle 200 to travel. The second motor generator 222 acts as a regenerative brake, for example, upon deceleration of the vehicle 200, to generate alternating-current power. The generated alternating-current power is input to the PCU 223.

Power Supply System

The power supply system 260 supplies electric power to each of the high-voltage devices and low-voltage devices. The power supply system 260 includes the main battery 261, the auxiliary equipment battery 262, and a DC-DC converter 263. The main battery 261 is mainly responsible for supplying electric power to high-voltage devices. The auxiliary equipment battery 262 is mainly responsible for supplying electric power to low-voltage devices. The power supply system 260 may further include, for example, a voltage sensor (not shown) and a current sensor (not shown).

Main Battery

The main battery 261 is a direct-current power supply. The rated output voltage of the main battery 261 can be, for example, about 200 V. The main battery 261 is a storage battery. The main battery 261 stores at least electric power to be supplied to the travel motor (the second motor generator 222 in the present embodiment). The main battery 261 may supply electric power also to any device other than the travel motor.

The main battery 261 should not be particularly limited. The main battery 261 may be, for example, a lithium-ion battery. The main battery 261 may be, for example, a nickel-hydrogen battery. The main battery 261 may be, for example, a fuel cell.

The main battery 261 supplies electric power to the first motor generator 221 and the second motor generator 222 via the PCU 223. The main battery 261 supplies electric power also to the DC-DC converter 263. The main battery 261 is charged with electric power generated by the first motor generator 221 and the second motor generator 222.

Auxiliary Equipment Battery

The auxiliary equipment battery 262 is a direct-current power supply. The rated output voltage of the auxiliary equipment battery can be, for example, about 12 V. The auxiliary equipment battery 262 is a storage battery. The auxiliary equipment battery 262 stores electric power to be supplied to the auxiliary equipment 270. In the present embodiment, the auxiliary equipment battery 262 includes the assembled battery 100 described above. The auxiliary equipment battery 262 may consist essentially of the assembled battery 100. The auxiliary equipment battery 262 is charged by receiving a supply of electric power from the main battery 261 via the DC-DC converter 263.

Auxiliary Equipment

The auxiliary equipment 270 is connected to the DC-DC converter 263 and the auxiliary equipment battery 262 by an electric power line. The auxiliary equipment 270 is driven by receiving a supply of electric power from at least one of the DC-DC converter 263 and the auxiliary equipment battery 262. The auxiliary equipment 270 includes, for example, power steering, an air conditioner, a small motor for a windshield wiper, a small motor for opening and closing doors, and an audio device.

ECU

The ECU 280 controls the various devices included in the vehicle 200. The ECU 280 includes, for example, a central processing unit (CPU), a memory, and an input/output buffer. The control by the ECU 280 may be executed by software. The control by the ECU 280 may be executed by specialized hardware (electronic circuit).

Start-Stop Vehicle

When the vehicle of the present embodiment is a gasoline engine vehicle, the vehicle may include a start-stop system. That is, the vehicle of the present embodiment may be a start-stop vehicle. In start-stop vehicles, electric power supplied to the various devices during operation of the start-stop system (during shut-down of the engine) is derived only from the auxiliary equipment battery. Additionally, shut-down and start-up of the engine are frequently repeated. Every start-up of the engine consumes electric power stored in the auxiliary equipment battery.

Thus, in start-stop vehicles, the SOC of the auxiliary equipment battery tends to be low. PbB, which has been conventionally used in auxiliary equipment batteries, tends to suffer deterioration in battery performance due to a phenomenon called sulfation when used continuously at a low SOC.

Furthermore, in start-stop vehicles, the auxiliary equipment battery undergoes high-current discharge every start-up of the engine. Additionally, it is desired for the auxiliary equipment battery to have a high charge efficiency in order to recover from the low-SOC state as quickly as possible. Thus, start-stop vehicles are required to have an auxiliary equipment battery capable of exhibiting good input/output characteristics at a low SOC.

When a start-stop vehicle incorporates an auxiliary equipment battery including the assembled battery 100 (i.e., a lithium-ion battery), the auxiliary equipment battery is expected to resist deterioration in battery performance even during use at a low SOC. Furthermore, the assembled battery 100 includes at least one third cell. The third cell includes a positive electrode active material including a lithium iron phosphate. The third cell is expected to exhibit good input/output characteristics even at a low SOC, because of the properties of the lithium iron phosphate. The inclusion of the assembled battery 100 in the auxiliary equipment battery is therefore expected to allow the auxiliary equipment battery to exhibit input/output characteristics appropriate for the start-stop vehicle.

Hereinafter, examples of the present disclosure will be described. It should be noted that the following description is not intended to limit the scope of the claims.

Various assembled batteries listed in Table 1 below were produced.

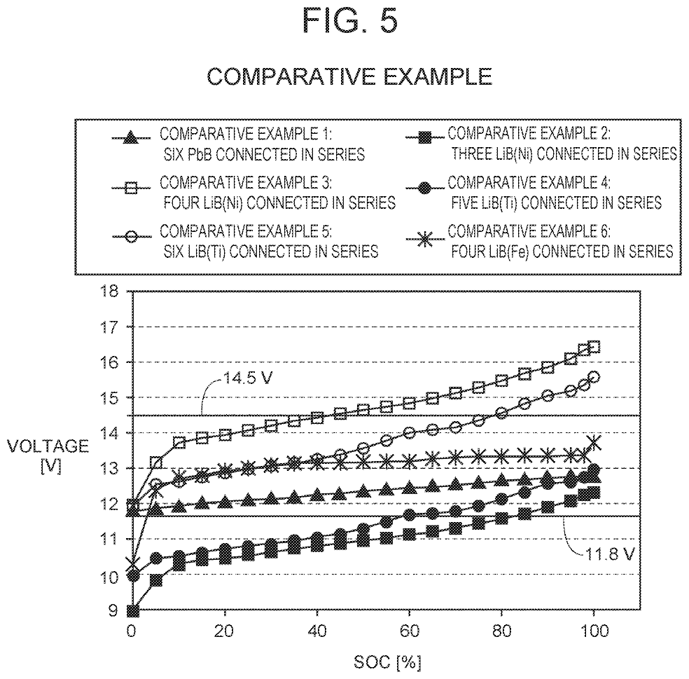

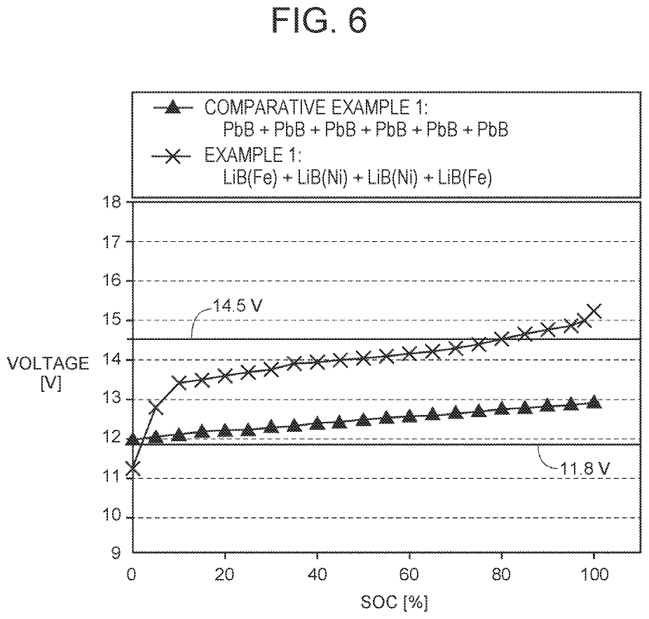

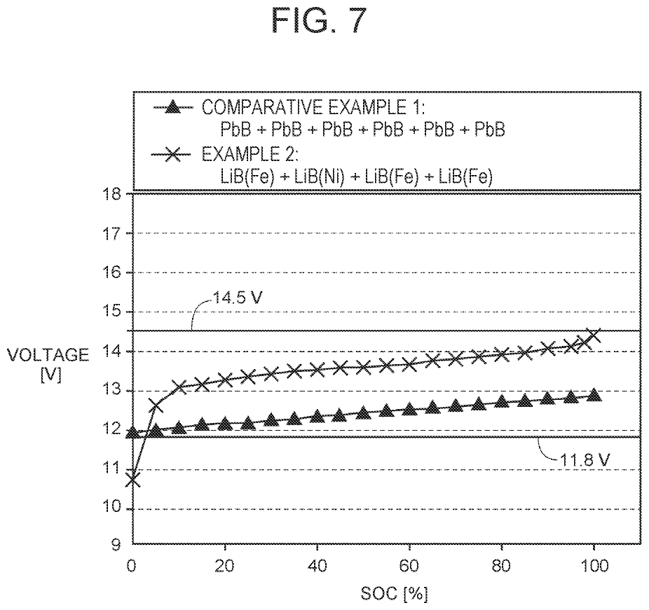

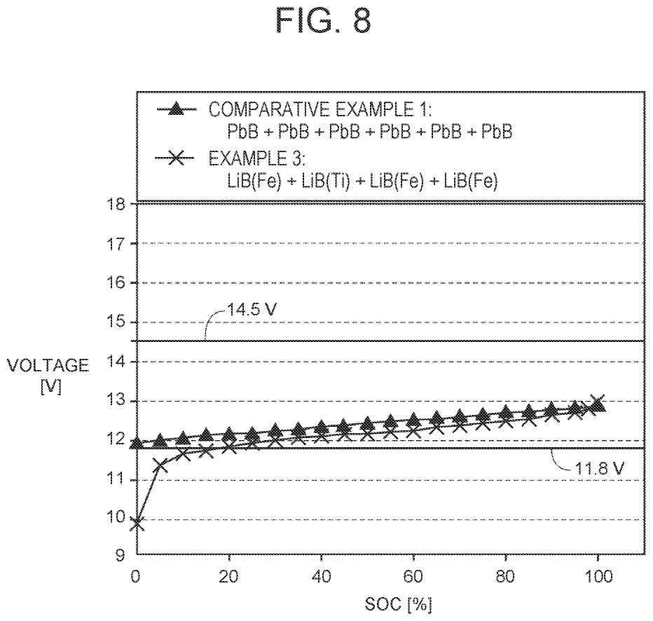

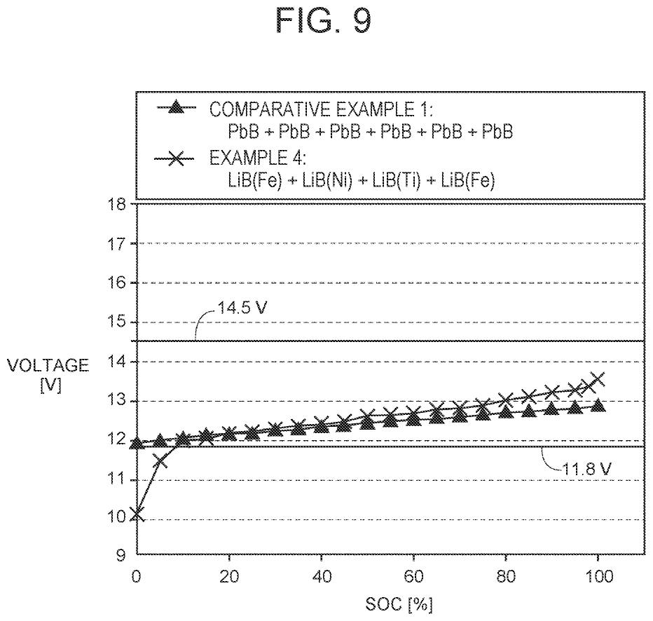

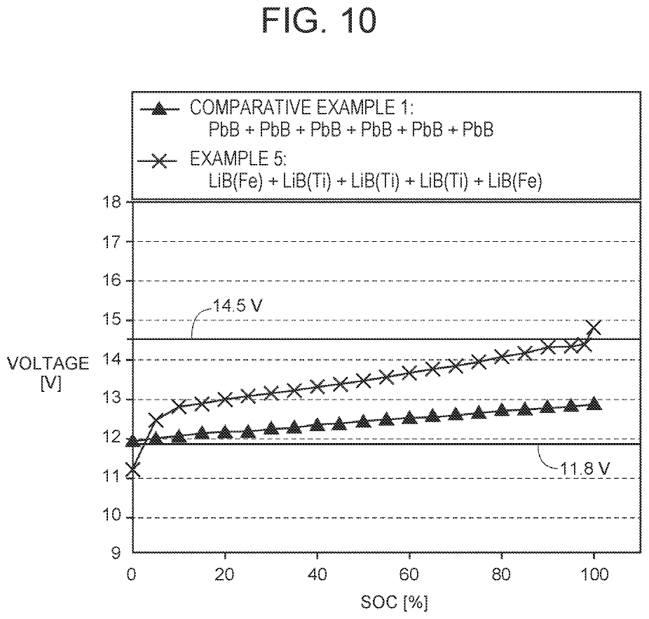

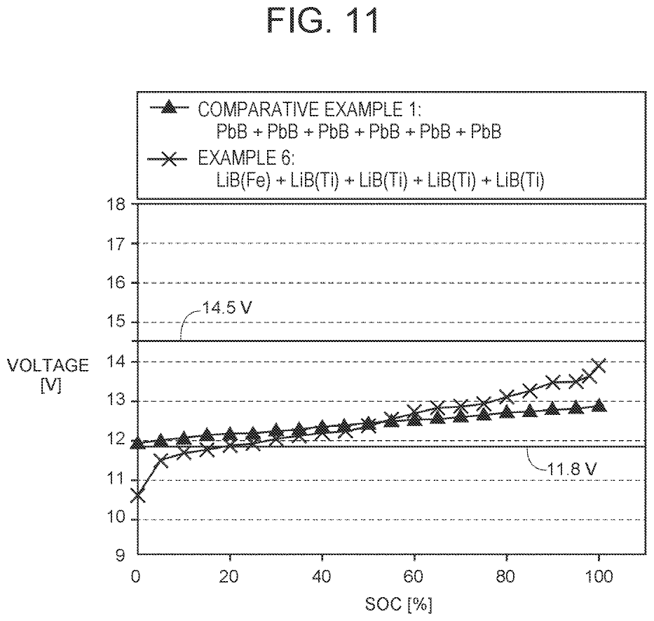

TABLE 1

| | | | | | | | Charge-discharge profile | | | | |
|---|---|---|---|---|---|---|---|---|---|---|---|
| | | | | | | | V₁ | V₂ | | Slope | |
| | | | | | | | 20% | 80% | | {(V₂ − V₁)/(80 − | |
| | Assembled battery | | | | | | SOC | SOC | V₂ − V₁ | 20)} × 1000 | |
| | Arrangement of cells | | | | | | [V] | [V] | [V] | [mV/%] | FIG. |
| Example 1 | LiB (Fe) | LiB (Ni) | LiB (Ni) | LiB (Fe) | | | 13.5 | 14.5 | 1.0 | 16.7 | FIG. 6 |
| Example 2 | LiB (Fe) | LiB (Ni) | LiB (Fe) | LiB (Fe) | | | 13.2 | 13.9 | 0.7 | 11.7 | FIG. 7 |
| Example 3 | LiB (Fe) | LiB (Ti) | LiB (Fe) | LiB (Fe) | | | 11.9 | 12.4 | 0.5 | 8.3 | FIG. 8 |
| Example 4 | LiB (Fe) | LiB (Ni) | LiB (Ti) | LiB (Fe) | | | 12.1 | 13.0 | 0.9 | 15.0 | FIG. 9 |
| Example 5 | LiB (Fe) | LiB (Ti) | LiB (Ti) | LiB (Ti) | LiB (Fe) | | 12.9 | 13.9 | 1.0 | 16.7 | FIG. 10 |
| Example 6 | LiB (Fe) | LiB (Ti) | LiB (Ti) | LiB (Ti) | LiB (Ti) | | 11.8 | 13.0 | 1.2 | 20.0 | FIG. 11 |
| Comparative Example 1 | PbB | PbB | PbB | PbB | PbB | PbB | 12.1 | 12.7 | 0.6 | 10.0 | FIG. 5 |
| Comparative Example 2 | LiB (Ni) | LiB (Ni) | LiB (Ni) | | | | 10.5 | 11.7 | 1.2 | 20.0 | FIG. 5 |
| Comparative Example 3 | LiB (Ni) | LiB (Ni) | LiB (Ni) | LiB (Ni) | | | 14.0 | 15.6 | 1.6 | 26.7 | FIG. 5 |
| Comparative Example 4 | LiB (Ti) | LiB (Ti) | LiB (Ti) | LiB (Ti) | LiB (Ti) | | 10.9 | 12.1 | 1.2 | 20.0 | FIG. 5 |
| Comparative Example 5 | LiB (Ti) | LiB (Ti) | LiB (Ti) | LiB (Ti) | LiB (Ti) | LiB (Ti) | 12.9 | 14.5 | 1.6 | 26.7 | FIG. 5 |
| Comparative Example 6 | LiB (Fe) | LiB (Fe) | LiB (Fe) | LiB (Fe) | | | 12.9 | 13.3 | 0.4 | 6.7 | FIG. 5 |

LiB (Ni): First cell
LiB (Ti): Second cell
LiB (Fe): Third cell
PbB: Lead storage battery

### Comparative Example 1

PbB for use in an auxiliary equipment battery was prepared as an assembled battery of Comparative Example 1. The assembled battery of Comparative Example 1 consists of six PbB (cells) connected in series. The voltages at an SOC of 20% and at an SOC of 80% are shown in Table 1 above. The charge-discharge profile of Comparative Example 1 is shown in each of FIGS. 5 to 11.

### Comparative Example 2

Three first cells (LiB(Ni)) were connected in series to produce an assembled battery of Comparative Example 2. The voltages at an SOC of 20% and at an SOC of 80% are shown in Table 1 above. The charge-discharge profile of Comparative Example 2 is shown in FIG. 5. The assembled battery of Comparative Example 2 has a voltage of less than 11.8 Vat an SOC of 20%.

### Comparative Example 3

Four first cells (LiB(Ni)) were connected in series to produce an assembled battery of Comparative Example 3. The voltages at an SOC of 20% and at an SOC of 80% are shown in Table 1 above. The charge-discharge profile of Comparative Example 3 is shown in FIG. 5. The assembled battery of Comparative Example 3 has a voltage of more than 14.5 V at an SOC of 80%.

### Comparative Example 4

Five second cells (LiB(Ti)) were connected in series to produce an assembled battery of Comparative Example 4. The voltages at an SOC of 20% and at an SOC of 80% are shown in Table 1 above. The charge-discharge profile of Comparative Example 4 is shown in FIG. 5. The assembled battery of Comparative Example 4 has a voltage of less than 11.8 V at an SOC of 20%.

### Comparative Example 5

Six second cells (LiB(Ti)) were connected in series to produce an assembled battery of Comparative Example 5. The voltages at an SOC of 20% and at an SOC of 80% are shown in Table 1 above. The charge-discharge profile is shown in FIG. 5. The assembled battery of Comparative Example 5 has the capacity region where the voltage is more than 14.5 V in a high-SOC range. The assembled battery of Comparative Example 5 has a large number of cells.

### Comparative Example 6

Four third cells (LiB(Fe)) were connected in series to produce an assembled battery of Comparative Example 6. The voltages at an SOC of 20% and at an SOC of 80% are shown in Table 1 above. The charge-discharge profile of Comparative Example 6 is shown in FIG. 5. The assembled battery of Comparative Example 6 presents a flat charge-discharge profile in the SOC range of 5% to 95%.

### Example 1

Two first cells (LiB(Ni)) and two third cells (LiB(Fe)) were connected in series to produce an assembled battery of Example 1. In the assembled battery of the Example 1, the third cells (LiB(Fe)) are disposed at both of the two ends in the arrangement direction. The voltages at an SOC of 20% and at an SOC of 80% are shown in Table 1 above.

FIG. 6 is a graph showing the relationship between SOC and voltage in the assembled battery of Example 1. The assembled battery of Example 1 has a voltage of 11.8 V or more and 14.5 V or less at an SOC of 20% or more and 80% or less. Further, the charge-discharge profile has a slope, which is thought to allow easy estimation of the SOC from the voltage.

The assembled battery of Example 1 has a voltage of 11.8 V or more and 14.5 V or less at an SOC of 5% or more and 80% or less.

### Example 2

One first cell (LiB(Ni)) and three third cells (LiB(Fe)) were connected in series to produce an assembled battery of Example 2. In the assembled battery of the Example 2, the third cells (LiB(Fe)) are disposed at both of the two ends in the arrangement direction. The voltages at an SOC of 20% and at an SOC of 80% are shown in Table 1 above.

FIG. 7 is a graph showing the relationship between SOC and voltage in the assembled battery of Example 2. The assembled battery of Example 2 has a voltage of 11.8 V or more and 14.5 V or less at an SOC of 20% or more and 80% or less. Further, the charge-discharge profile has a slope, which is thought to allow easy estimation of the SOC from the voltage.

The assembled battery of Example 2 has a voltage of 11.8 V or more and 14.5 V or less at an SOC of 5% or more and 100% or less.

### Example 3

One second cell (LiB(Ti)) and three third cells (LiB(Fe)) were connected in series to produce an assembled battery of Example 3. In the assembled battery of Example 3, the third cells (LiB(Fe)) are disposed at both of the two ends in the arrangement direction. The voltages at an SOC of 20% and at an SOC of 80% are shown in Table 1 above.

FIG. 8 is a graph showing the relationship between SOC and voltage in the assembled battery of Example 3. The assembled battery of Example 3 has a voltage of 11.8 V or more and 14.5 V or less at an SOC of 20% or more and 80% or less. Further, the charge-discharge profile has a slope, which is thought to allow easy estimation of the SOC from the voltage.

The assembled battery of Example 3 has a voltage of 11.8 V or more and 14.5 V or less at an SOC of 20% or more and 100% or less.

The charge-discharge profile of the assembled battery of Example 3 in the SOC range of 20% to 100% is similar to that of the assembled battery (PbB) of

Comparative Example 1.

### Example 4

One first cell (LiB(Ni)), one second cell (LiB(Ti)), and two third cells (LiB(Fe)) were connected in series to produce an assembled battery of Example 4. In the assembled battery of Example 4, the third cells (LiB(Fe)) are disposed at both of the two ends in the arrangement direction. The voltages at an SOC of 20% and at an SOC of 80% are shown in Table 1 above.

FIG. 9 is a graph showing the relationship between SOC and voltage in the assembled battery of Example 4. The assembled battery of Example 4 has a voltage of 11.8 V or more and 14.5 V or less at an SOC of 20% or more and 80% or less. Further, the charge-discharge profile has a slope, which is thought to allow easy estimation of the SOC from the voltage.

The assembled battery of Example 4 has a voltage of 11.8 V or more and 14.5 V or less at an SOC of 10% or more and 100% or less.

The charge-discharge profile of the assembled battery of Example 4 in the SOC range of 10% to 95% is similar to that of the assembled battery (PbB) of Comparative Example 1.

### Example 5

Three second cells (LiB(Ti)) and two third cells (LiB(Fe)) were connected in series to produce an assembled battery of Example 5. In the assembled battery of Example 5, the third cells (LiB(Fe)) are disposed at both of the two ends in the arrangement direction. The voltages at an SOC of 20% and at an SOC of 80% are shown in Table 1 above.

FIG. 10 is a graph showing the relationship between SOC and voltage in the assembled battery of Example 5. The assembled battery of Example 5 has a voltage of 11.8 V or more and 14.5 V or less at an SOC of 20% or more and 80% or less. Further, the charge-discharge profile has a slope, which is thought to allow easy estimation of the SOC from the voltage.

The assembled battery of Example 5 has a voltage of 11.8 V or more and 14.5 V or less at an SOC of 5% or more and 95% or less.

### Example 6

Four second cells (LiB(Ti)) and one third cell (LiB(Fe)) were connected in series to produce an assembled battery of Example 6. In the assembled battery of Example 6, the third cell (LiB(Fe)) is disposed at one end in the arrangement direction, and the second cells (LiB(Ti)) are disposed at the other end in the arrangement direction. The voltages at an SOC of 20% and at an SOC of 80% are shown in Table 1 above.

FIG. 11 is a graph showing the relationship between SOC and voltage in the assembled battery of Example 6. The assembled battery of Example 6 has a voltage of 11.8 V or more and 14.5 V or less at an SOC of 20% or more and 80% or less. Further, the charge-discharge profile has a slope, which is thought to allow easy estimation of the SOC from the voltage.

The assembled battery of Example 6 has a voltage of 11.8 V or more and 14.5 V or less at an SOC of 20% or more and 100% or less.

The embodiment and examples of the present disclosure are illustrative in all respects and not restrictive. The technical scope defined by the claims embraces all changes which come within the meaning and range of equivalency of the claims.

What is claimed is:

1. An assembled battery comprising a cell group, wherein
the cell group includes a plurality of cells connected in series,
each of the plurality of cells is a lithium-ion battery,
the cell group includes:
at least one of a first cell or a second cell; and
at least one third cell,
the first cell includes a positive electrode active material containing a lithium-nickel composite oxide,
the second cell includes a negative electrode active material containing a lithium-titanium composite oxide,
the third cell includes a positive electrode active material containing a lithium iron phosphate, and
a voltage of the assembled battery is within a range of 11.8 V to 14.5 V in a case where an SOC of the assembled battery is within a range of 20% to 80%.

2. The assembled battery according to claim 1, wherein
the plurality of cells are arranged in a row, and
the at least one third cell is disposed at at least one of two ends in a direction in which the plurality of cells are arranged in the row.

3. The assembled battery according to claim 1, wherein
the cell group includes the at least one second cell,
the plurality of cells are arranged in a row, and
the at least one second cell is disposed at at least one of two ends in a direction in which the plurality of cells are arranged in the row.

4. The assembled battery according to claim 1, wherein
a difference between the voltage at the SOC of 80% and the voltage at the SOC of 20% is 0.5 V or more.

5. The assembled battery according to claim 1, wherein
the cell group consists of four cells.

6. The assembled battery according to claim 1, wherein
the cell group consists of five cells.

7. A vehicle comprising:
at least one of a travel motor and an engine;
auxiliary equipment; and
an auxiliary equipment battery, wherein
the auxiliary equipment battery is configured to store electric power to be supplied to the auxiliary equipment, and
the auxiliary equipment battery includes the assembled battery according to claim 1.

8. The vehicle according to claim 7, further comprising:
the travel motor; and
a main battery, wherein
the main battery in configured to store at least electric power to be supplied to the travel motor.

9. A method of manufacturing an assembled battery, comprising:
preparing a plurality of cells;
connecting the plurality of cells in series to form a cell group; and
producing the assembled battery including the cell group, wherein
each of the plurality of cells is a lithium-ion battery,
the cell group includes:
at least one of a first cell or a second cell; and
one or more third cells,
the first cell includes a positive electrode active material containing a lithium-nickel composite oxide,
the second cell includes a negative electrode active material containing a lithium-titanium composite oxide,
the third cell includes a positive electrode active material containing a lithium iron phosphate, and
the number of the first cells, the number of the second cells, and the number of the third cells included in the cell group are chosen to allow a voltage of the assembled battery to be within a range of 11.8 V to 14.5 V in a case where an SOC of the assembled battery is within a range of 20% to 80%.
